(19) United States
(12) Patent Application Publication
(10) Pub. No.: US 2026/0077740 A1
(43) Pub. Date: Mar. 19, 2026

(54) CATALYTIC CONVERTER THEFT DETERRENT DISCOVERY

(71) Applicant: E and Y Innovations, Bethlehem, PA (US)

(72) Inventors: Michael Yoder, Bethlehem, PA (US); Brian Engleman, Pottsville, PA (US)

(73) Assignee: E and Y Innovations, Bethlehem, PA (US)

(21) Appl. No.: 18/887,352

(22) Filed: Sep. 17, 2024

(51) Int. Cl. B60R 25/104; B60R 25/30; H04N 7/18

(52) U.S. Cl. CPC B60R 25/104; B60R 25/305; H04N 7/185

(57) ABSTRACT

A vehicle catalytic converter theft prevention system features a robust housing containing a power source, advanced control circuitry, sensors, multiple alarms, and a communication module. The control circuitry is designed to continuously monitor the sensors for any signs of motion or tampering. Upon detecting suspicious activity, such as movement or vibration indicative of a theft attempt, the control circuitry immediately activates the alarms, which include loud sirens, flashing lights, and notifications sent to the vehicle owner's smartphone via the communication module. This system ensures rapid deterrence and reporting of any theft attempts, providing reliable protection for the vehicle's catalytic converter.

### FIELD

The present invention relates to B60R 25/00 for anti-theft devices for vehicles, specifically B60R 25/24 for anti-theft means for vehicle parts or accessories, and B60R 25/22 for electrical circuits or systems specially adapted for anti-theft purposes.

### BACKGROUND

Currently, a surge in catalytic converter thefts has created significant problems for vehicle owners, highlighting the urgent need for an effective prevention and deterrent system. Catalytic converters contain precious metals like platinum, palladium, and rhodium, making them lucrative targets for thieves. Thieves can easily and swiftly remove catalytic converters using modern tools like battery-powered Sawzall's and/or grinders. The thefts are often quick and occur in plain sight, leaving vehicle owners with expensive repair costs and prolonged periods without their vehicles. Traditional anti-theft measures, such as etching identification numbers onto converters or using simple physical locks, have proven inadequate in deterring determined thieves. Furthermore, these measures do not provide real-time alerts or involve law enforcement, leaving vehicle owners unaware until the damage is done. These products are typically expensive to purchase, limiting their accessibility to a broad range of users. Additionally, they often require lengthy and complex installation processes, resulting in high installation costs as professional services are usually needed.

Moreover, these solutions do not effectively prevent theft; they only prolong the time required to remove the catalytic converter. While this delay might deter some thieves, it does not provide a robust deterrent against determined criminals, who can still succeed in stealing the converter. Recently, the severity of this issue has escalated, with some thefts resulting in the tragic deaths of vehicle owners attempting to confront the thieves. This alarming trend underscores the urgent need for a more efficient, cost-effective, and user-friendly catalytic converter theft prevention system. Such a system must offer comprehensive protection without the drawbacks associated with current products, ensuring both the safety of the vehicle and its owner. Thus, there is a need for a more efficient, cost-effective, and user-friendly catalytic converter theft prevention system. This system should provide comprehensive protection by being easy to install, affordable, and capable of effectively deterring theft attempts. Additionally, it must ensure the safety of both the vehicle and its owner, addressing the serious consequences that can arise from confrontations with thieves.

### SUMMARY OF INVENTION

The current invention addresses these issues by offering a system that is easy to install, ensuring broad accessibility and user-friendliness. It incorporates audio and visual alarms that create a scene during attempted thefts, attracting attention and deterring criminals. The system's wireless notification capability ensures that users receive immediate alerts on their cellphones or other devices, enabling quick response and involvement of authorities. Additionally, the integration with the vehicle's battery provides a consistent power source, while false alarm prevention mechanisms enhance reliability. These features collectively provide a solution to the escalating problem of catalytic converter thefts, offering vehicle owners greater security and peace of mind.

As noted above, the user requirements for the catalytic converter theft prevention system encompass several features. Firstly, the system may be straightforward to install, facilitating ease of use for a diverse range of consumers. The system may provide wireless alerts to the user via text messages sent to their cellphones or other electronic devices, ensuring immediate awareness of any tampering. To effectively deter potential thieves, the system may incorporate deterrent mechanisms such as strobe or bright lights, alarms and/or sirens. A quieter option, such as a “now recording” message, is preferable to reduce the incidence of false positives and should be prioritized. Additionally, the system may operate using the vehicle's battery without depleting it for a minimum duration of two months. This entails having its own battery that recharges from the vehicle battery and ceases recharging if the vehicle battery's voltage drops below a certain threshold. Furthermore, the system may automatically deactivate when the vehicle is in operation to prevent unnecessary alerts. The target consumer profile for this product includes RV drivers and dealers, car drivers and dealers, as well as companies that manage large fleets of vehicles.

In some aspects, the techniques described herein relate to a theft deterrent device for a catalytic converter for a vehicle, including: a housing, including: a power source; a control logic circuitry electrically connected to the power source; one or more sensors electrically connected to the power source and to the control logic circuitry; one or more alarms electrically connected to the power source and to the control logic circuitry; a communication processor electrically connected to the control logic circuitry; and the control logic circuitry configured to: in response to detecting motion from a first sensor of the one or more sensors, activate the one or more alarms.

In some aspects, the techniques described herein relate to a theft deterrent device for a catalytic converter for a vehicle, wherein the one or more sensors is located within a proximity to the catalytic converter of the vehicle.

In some aspects, the techniques described herein relate to a theft deterrent device for a catalytic converter for a vehicle, wherein the communication processor is a transceiver.

In some aspects, the techniques described herein relate to a theft deterrent device for a catalytic converter for a vehicle, wherein the one or more alarms is a light emitting diode.

In some aspects, the techniques described herein relate to a theft deterrent device for a catalytic converter for a vehicle, wherein the light emitting diode is electrically connected to a strobe controller.

In some aspects, the techniques described herein relate to a theft deterrent device for a catalytic converter for a vehicle, wherein the one or more alarms is a speaker electrically connected to a driver circuit to emit an audio signal.

In some aspects, the techniques described herein relate to a theft deterrent device for a catalytic converter for a vehicle, wherein the power source is a rechargeable battery to be energized by a power source of the vehicle.

In some aspects, the techniques described herein relate to a theft deterrent device for a catalytic converter for a vehicle, further including: a limit switch electrically connected to the power source and to a voltage regulator, the voltage regulator in communication with the power source of the vehicle.

In some aspects, the techniques described herein relate to a theft deterrent device for a catalytic converter for a vehicle, further including a second sensor of the one or more sensors being a camera.

In some aspects, the techniques described herein relate to a theft deterrent device for a catalytic converter for a vehicle, wherein the control logic circuitry is further to: analyze data collected from the first sensor of the one or more sensors; and activate the camera when a presence of motion is detected by the first sensor.

In some aspects, the techniques described herein relate to a theft deterrent device for a catalytic converter for a vehicle, further including: a remote database; the control logic circuitry is further to: transmit one or more videos captured by the camera to the remote database.

In some aspects, the techniques described herein relate to a method for detecting movement at a catalytic converter of a vehicle, including: disposing a theft deterrent device at the catalytic converter of the vehicle; implementing the theft deterrent device, including: a housing, including: a power source; one or more sensors electrically connected to the power source; one or more alarms electrically connected to the power source; a communication processor; a memory circuit storing computer executable instructions; and a processing device, wherein execution of the computer executable instructions by the processing device, causes the processing device to: in response to detecting motion from a first sensor of the one or more sensors, initiate a system setup; establishing a network connection using a startup subroutine; and transmitting startup data to a startup routine; determining a presence of detected motion at the catalytic converter; evaluating if the detected motion exceeds a predefined threshold; and activating an alert subroutine when the detected motion exceeds the predefined threshold.

In some aspects, the techniques described herein relate to a method, wherein the alert subroutine activates the one or more alarms to illuminate one or more light emitting diodes.

In some aspects, the techniques described herein relate to a method, wherein the alert subroutine activates the one or more alarms is to emit an audio signal from a speaker electrically connected to a driver circuit.

In some aspects, the techniques described herein relate to a device, including: a housing, including: a power source; a control logic circuitry electrically connected to the power source; one or more sensors electrically connected to the power source and to the control logic circuitry; one or more alarms electrically connected to the power source and to the control logic circuitry; a communication processor electrically connected to the control logic circuitry; and the control logic circuitry configured to: in response to detecting motion at a catalytic converter of a vehicle from a first sensor of the one or more sensors, activate the one or more alarms.

In some aspects, the techniques described herein relate to a device, wherein the one or more sensors is located within a proximity to the catalytic converter of the vehicle.

In some aspects, the techniques described herein relate to a device, wherein the communication processor is a transceiver.

In some aspects, the techniques described herein relate to a device, wherein the one or more alarms is a light emitting diode.

In some aspects, the techniques described herein relate to a device, wherein the light emitting diode is electrically connected to a strobe controller.

In some aspects, the techniques described herein relate to a device, wherein the one or more alarms is a speaker electrically connected to a driver circuit to emit an audio signal.

These together with additional objects, features and advantages of the systems and methods of fraud identification will be readily apparent to those of ordinary skill in the art upon reading the following detailed description of the presently preferred, but nonetheless illustrative, embodiments when taken in conjunction with the accompanying drawings.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a systems diagram of circuitry implemented within a housing of a catalytic converter theft prevention device in accordance with some embodiments.

FIG. 2 is a block diagram illustrating a method for processing a presence of detected motion in the converter theft prevention system of FIG. 1 in accordance with some embodiments.

FIG. 3A is a flowchart illustrating the method of FIG. 2 for detecting movement at a catalytic converter of a vehicle in accordance with some embodiments.

FIG. 3B is a flowchart extending from FIG. 3A and further illustrating the method for detecting movement at a catalytic converter of a vehicle in accordance with some embodiments.

### DETAILED DESCRIPTION

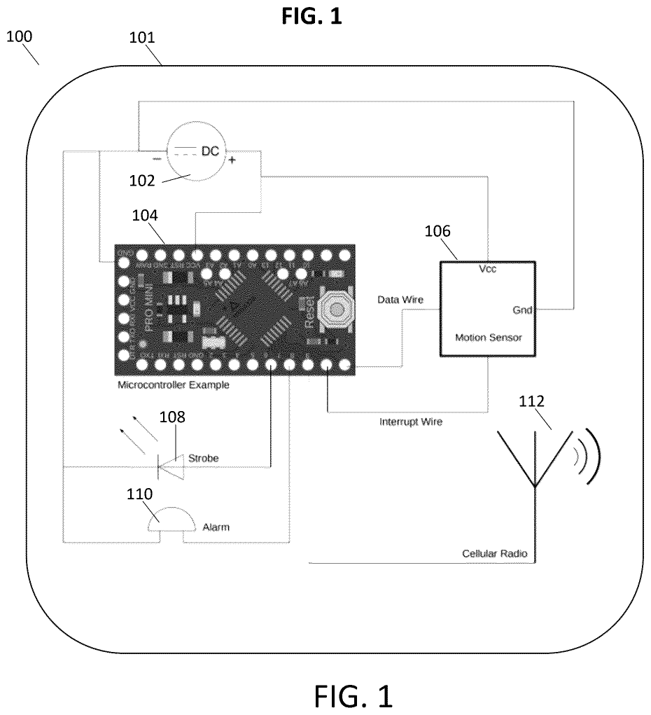

FIGS. 1-3B illustrate example devices, methods and processes to implement one or more sensors to detect the presence of motion in a converter theft prevention system for a vehicle. A theft deterrent device of FIG. 1 configured for movement detection of a vehicle's catalytic converter includes a housing with a power source, control logic circuitry, sensors, alarms, and a communication processor. The control logic circuitry is designed to activate the alarms upon detecting motion by a sensor, providing an effective deterrent against theft.

FIG. 1 illustrates a theft deterrent device 100 for a vehicle's catalytic converter (not shown) that includes a housing 101 with a power source 102 and a control logic circuitry 104 is connected to it. The housing 101 also incorporates one or more sensors 106 and one or more alarms such as visual alarm 108 and audio alarm 110 both electrically linked to the power source 102 and the control logic circuitry 104. Additionally, a communication processor 112 is connected to the control logic circuitry 104. The control logic circuitry 104 is configured to activate the visual alarms 108 and/or audio alarm 110 upon detecting motion from any of one or more sensors 106, thereby alerting against potential theft attempts. In implementations, the one or more sensors 106 is a motion sensor configured for sensing motion. The catalytic converter is communicating to the control logic circuitry 104, such as a microchip, whether motion is present or not. The control logic circuitry 104 transmits a signal to the communication processor 112 such as a cellular phone, as an example.

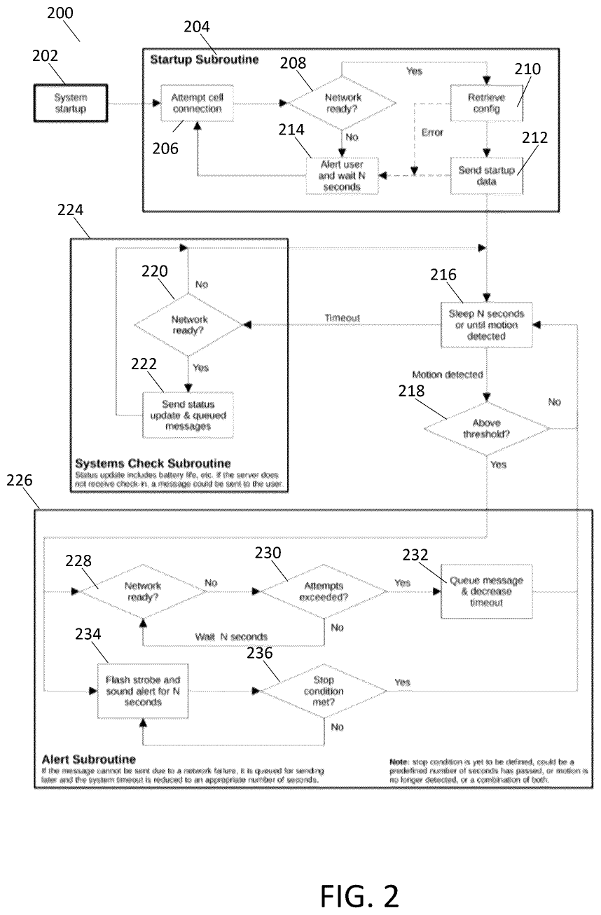

FIG. 2 is a flow chart illustrating a method 200 for processing a presence of detected motion in the converter theft prevention system of FIG. 1. At block 202, the system startup processor is in communication with a startup subroutine. At block 204, a startup subroutine initiates a cell connection and verifies network readiness. At block 206, a cell connection is attempted. At block 208, upon confirmation of network availability, it proceeds to retrieve configuration settings. At block 214, in case of an error during this process, the subroutine alerts the user and enters a waiting state for a specified duration, denoted as N seconds. At block 210, if no errors are encountered, the subroutine proceeds to transmit startup data as intended. This sequence ensures that the startup procedure is robust, effectively handling network errors while facilitating the retrieval and transmission of necessary configuration and operational data.

At block 212, the startup routine initiates by transmitting the startup data and then enters a sleep state for N seconds or until motion is detected. At block 224, if a timeout occurs during this period, the system checks the network readiness. At block 220, if the network is not ready, it resumes sleeping for N seconds or until motion is detected once more. At block 222, upon confirming network readiness, the system sends a status update that includes information such as battery life and queues any pending messages. In the event that the server does not receive the expected check-in, a notification is sent to the user. At block 216, when motion is detected, the system evaluates whether the detected motion surpasses a predefined threshold. At block 218, if the motion exceeds this threshold, the system proceeds to an alert subroutine to manage the situation accordingly. If the detected motion does not meet the threshold criteria, the system returns to a sleep state for N seconds or waits until motion is detected again. This sequence ensures that the startup routine and subsequent motion detection processes are systematically managed, providing robust monitoring and alert functionalities in response to varying conditions.

At block 226, an alert subroutine is triggered under various conditions. At block 228, if a message cannot be sent due to a network failure, it is queued for later transmission, and the system adjusts its timeout duration to an appropriate number of seconds. The stop condition for this subroutine may involve a predefined elapsed time, the absence of detected motion, or a combination thereof, which will be defined later.

At block 230, if the network is not ready, the system checks if the maximum attempts to establish connection have been exceeded. At block 232, if the attempts have been exceeded, the message is queued for later transmission, and the timeout duration is decreased accordingly. If the attempts have not been exceeded, the system waits for N seconds and then determines if the message can be sent. At block 236, if the stop condition has not been met, the system activates a strobe light and sound alert for N seconds. At block 234, a light-emitting diode may illuminate and/or flash intermittently and/or an audio alert may emit a sound for a predetermined amount of time. This subroutine ensures handling of network failures and communication retries, while also incorporating visual and auditory alerts to notify users of system status or potential threats. The dynamic adjustment of timeouts and alert activations based on network conditions and user-defined parameters enhances the overall reliability and responsiveness of the system in monitoring and alerting scenarios.

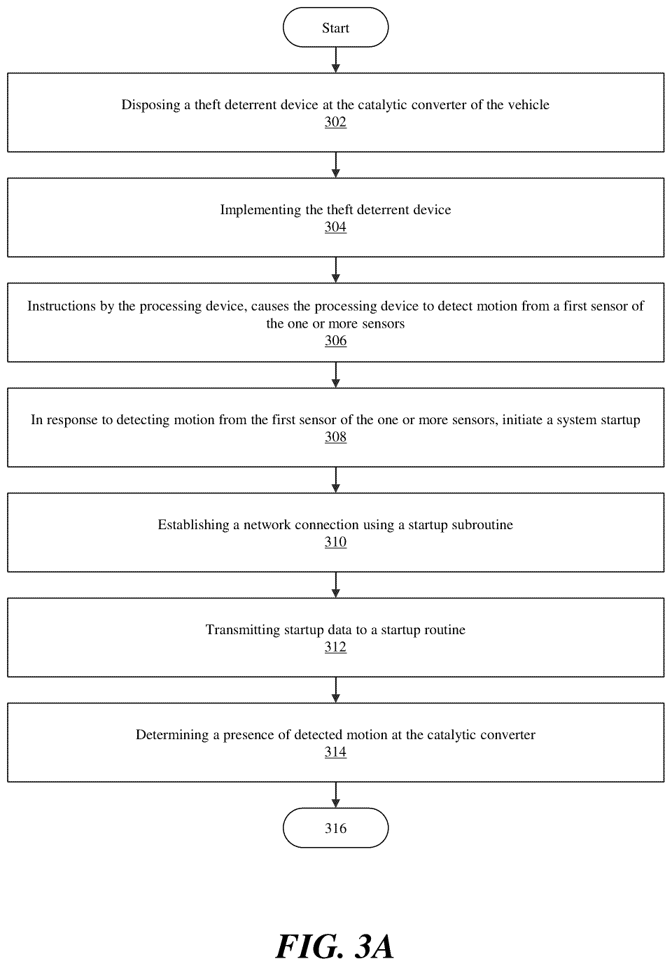

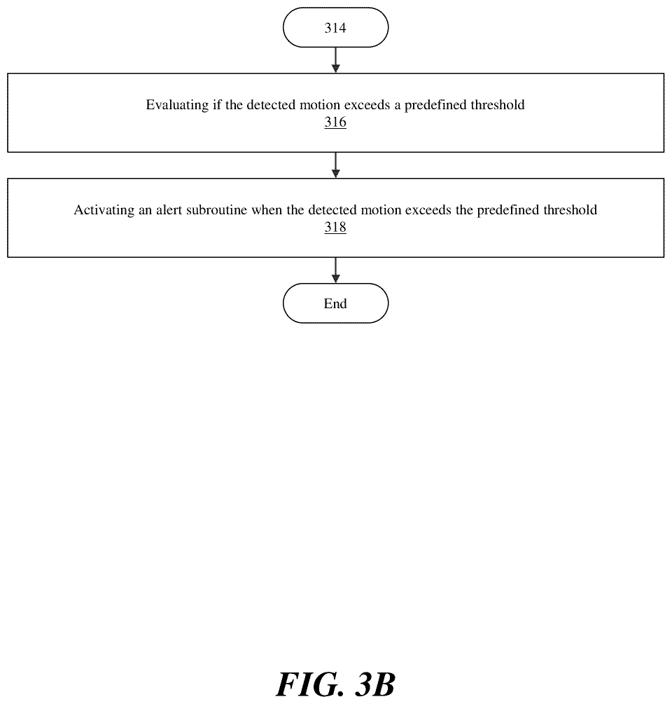

FIGS. 3A to 3B are flowcharts that describe the method of FIG. 2 for detecting movement at a catalytic converter of a vehicle, according to some embodiments of the present disclosure. In some embodiments, at block 302, the method may include disposing a theft deterrent device at the catalytic converter of the vehicle. At block 304, the method may include implementing a theft deterrent device. At block 306, the implementing may include, instructions by the processing device, causes the processing device to detect motion from a first sensor of the one or more sensors. At block 308, in response to detecting motion from the first sensor of the one or more sensors, initiate a system setup. At block 310, the implementing may include establishing a network connection using a startup subroutine. At block 312, the implementing may include transmitting startup data to a startup routine. At block 314, the implementing may include determining a presence of detected motion at the catalytic converter. At block 316, the implementing may include evaluating if the detected motion exceeds a predefined threshold. At block 318, the implementing may include activating an alert subroutine when the detected motion exceeds the predefined threshold.

In implementations, a motion sensor is in communication with a catalytic converter, whereby the motion sensor detects motion from the catalytic converter. The sensor sends a signal to a processing device. The processing device activates a strobe light, an audio alarm, and/or a strobe light concurrently with an audio alarm and also sending a signal to a cellular phone. The strobe light serves as a powerful visual deterrent. Upon activation, it emits intense, flashing bursts of light designed to disorient and draw attention to any unauthorized activity around the vehicle. The rapid and bright flashes of the strobe light are highly effective in startling potential thieves, making it difficult for them to continue their illicit actions without being noticed. The unpredictability and intensity of the strobe light create a sense of urgency and fear, compelling the thief to abandon their attempt and flee the scene. Complementing the strobe light, the audible alarm provides an equally potent auditory deterrent. When triggered, the alarm emits a loud, piercing sound that is designed to alert anyone in the vicinity to the presence of a potential theft. The high-decibel noise serves to scare off the intruder while simultaneously attracting attention from passersby and nearby residents. This dual effect increases the likelihood of intervention and reduces the chances of the thief successfully stealing the catalytic converter.

As noted above, together, the strobe light and audible alarm create a formidable defense mechanism. By combining intense visual and auditory stimuli, the system maximizes the deterrent effect, ensuring that potential thieves are both disoriented and exposed, thereby significantly reducing the risk of catalytic converter theft. The technical hardware components involved in generating alarms for sound and light in a theft prevention system include a siren for audible alerts and a strobe light for visual alerts. The siren consists of a high-decibel speaker designed to emit loud sounds, which is typically weatherproof and robust to withstand outdoor conditions. It is driven by a driver circuit, an electronic component that amplifies the audio signal to ensure the alarm is loud enough to be effective. This driver circuit is activated by a microcontroller, the central processing unit that processes input from sensors and triggers the siren when motion or unauthorized access is detected. Similarly, the strobe light comprises high-intensity light-emitting diodes (LEDs) that produce bright, flashing lights. These LEDs are chosen for their energy efficiency and longevity. The flashing pattern of the LEDs is controlled by a strobe controller, an electronic circuit that ensures the strobe light flashes at a specific frequency to maximize its visual deterrent effect. Like the siren, the strobe light is also controlled by the microcontroller, which communicates with the strobe controller to manage the flashing sequence. The integration of these components—siren, strobe light, driver circuit, strobe controller, and microcontroller—ensures that the theft prevention system can respond quickly and effectively to potential threats by deploying both auditory and visual deterrents.

In implementations, a power source, denoted as DC, supplies independent power to both the microcontroller and the motion sensing device, ensuring their uninterrupted operation. When the motion sensor detects any movement, it sends an interrupt signal to the microcontroller, thereby triggering the system's alert mechanisms. Concurrently, the motion sensor transmits motion data to the microcontroller via a dedicated wire, allowing for precise monitoring and response. The microcontroller, serving as the central processing unit of the system, manages the activation of the strobe light and audible alarm through designated control pins. These components are strategically employed to create both visual and auditory deterrents, effectively dissuading potential thieves. Additionally, the microcontroller controls the cellular radio, which is crucial for the system's communication capabilities. For the purposes of the prototype, the cellular radio is likely integrated as part of the microcontroller, streamlining the design and simplifying the development process.

In further implementations, the catalytic converter theft prevention system may incorporate one or more sensors to enhance its functionality and effectiveness. These sensors can include, but are not limited to, a variety of detection and deterrence mechanisms such as cameras, strobe lights, light-emitting units, audible alarms, and vibration sensors. The integration of a camera enables real-time monitoring and recording of any suspicious activity around the vehicle. Strobe lights and light-emitting units serve as visual deterrents, designed to startle and dissuade potential thieves. Audible alarms can produce loud sounds to draw attention and scare off intruders. Additionally, vibration sensors can detect physical tampering with the vehicle, triggering the system's alert mechanisms. Furthermore, these sensors can be connected to an electrical communication network within the system, interfacing with motion sensors to detect unauthorized movement around the catalytic converter. Upon detecting suspicious activity, the system can promptly send notifications, such as text messages or emails, to the vehicle owner. This immediate alert capability ensures that the owner is aware of potential threats in real time, allowing for quick response and intervention. By leveraging these advanced sensor technologies, the catalytic converter theft prevention system provides a comprehensive and proactive approach to safeguarding vehicles against theft.

The project assumptions and requirements for the catalytic converter theft prevention system are predicated on several key considerations. The equipment and electronics required will have a low power draw, remaining in a low-power sleep mode for the majority of the time to conserve energy. Eliminating false positives is not a primary focus of this project. The system is intended for installation on recreational vehicles (RVs), trucks, and cars, necessitating a versatile design adaptable to different vehicle types. The environmental and material requirements are critical to ensuring the system's reliability and durability. The system must include an alert mechanism for low battery levels and remain in sleep mode most of the time to minimize power consumption. It should be capable of sending text message alerts to notify the user of potential theft attempts. The final product must be able to withstand extreme parking lot temperatures and be robust enough to endure the harsh environmental conditions found under vehicles.

The functional requirements of the system are comprehensive, encompassing several essential features. It should include a cell chip for sending text messages and a method to connect the device to the vehicle's battery, either via the OBDII port or another means, to recharge the onboard battery. The system must feature a strobe light for visual deterrence and a speaker capable of emitting a loud “You are being recorded” message to dissuade potential thieves. Additionally, the system should incorporate hardware to detect human presence using one or more sensors including, but not limited to, utilizing motion, ultrasonic, or infrared sensors, or a combination thereof, similar to a trail camera. The potential inclusion of an SD card or Bluetooth capability for transmitting recordings further enhances the system's functionality. These features collectively aim to create a reliable, durable, and effective theft prevention system suitable for various vehicle types and environmental conditions.

The proposed solutions for the catalytic converter theft prevention system encompass a range of critical components and features, aimed at delivering an effective and user-friendly product. The initial prototype will include a camera activated by a motion sensor, which will perform motion checks every five seconds, entering a sleep mode otherwise to optimize energy usage. Additionally, the system will feature a speaker that emits a “recording” warning, a strobe light for visual deterrence, and a battery that charges from the vehicle's battery but stops charging when a specific voltage threshold is reached. The prototype will also integrate a cell chip for sending text alerts, an SD card for file storage and transmission, and a Bluetooth chip for wireless file transfer. To facilitate installation, the prototype will include a mounting bracket for secure attachment to the vehicle's frame and a robust housing to encase all components.

Future enhancements may include replacing the standard speaker with a siren if the “recording” warning is not sufficiently effective. The inclusion of the cell chip, SD card, and Bluetooth chip will be assessed to determine the optimal combination of these features. A detailed system diagram is available in the appendix for reference. The list of electrical components and hardware required is still to be finalized. The manufacturing processes for the prototype will involve the production of printed circuit boards (PCBs) using pick-and-place technology, with the housing being produced through injection molding. The user experience, encompassing aspects such as purchasing, installation, and operation, is currently under development and will be refined in subsequent stages. By integrating these features and adhering to the proposed solutions, the catalytic converter theft prevention system aims to provide a robust, reliable, and user-friendly solution for vehicle owners, effectively addressing the pressing issue of catalytic converter theft.

The catalytic converter theft prevention system features a speaker capable of emitting a loud, clear message: “You are being recorded.” This auditory component is designed to function as a powerful deterrent against theft. When the motion sensor detects unauthorized activity near the vehicle, the speaker is activated, delivering the pre-recorded warning at a high volume. The purpose of this message is twofold. First, it serves to immediately alert the intruder that their actions are being monitored and recorded, which increases the perceived risk of being caught and prosecuted. The explicit warning that a recording is in progress can induce panic and prompt the thief to abandon their efforts and leave the area swiftly. Second, the loud message draws the attention of people nearby, further increasing the chances of intervention or the thief being spotted and reported. By using a verbal warning instead of just a siren or alarm, the system conveys a specific and intimidating message, making it clear to the potential thief that their identity and actions are being documented. The combination of the strobe light, audible alarm, and the spoken warning creates a comprehensive deterrent strategy. The speaker's ability to deliver the “You are being recorded” message enhances the overall effectiveness of the theft prevention system by leveraging psychological deterrence in addition to physical alerts.

Further, in implementations, a microphone is necessary to capture audio signals, converting them into electrical signals for processing. These signals are then stored on a storage medium such as an SD card or internal memory, providing sufficient capacity to store recordings over an extended period. A microcontroller or processor manages the recording process, coordinating interactions between the microphone, storage medium, and other system components. Reliable power supply is critical for continuous operation, typically sourced from the vehicle's main battery or a dedicated power source. Interfaces are needed to control recording functions, including initiation, termination, and storage management, which may involve hardware buttons, sensors, or software controls integrated into the system. Optionally, a communication module like Bluetooth or Wi-Fi enables wireless transmission of recorded files to external devices or servers. Lastly, a robust housing protects the recording hardware from environmental factors and vibrations, ensuring durability and reliability in diverse operating conditions. These components collectively enable effective audio recording as part of the catalytic converter theft prevention system, enhancing its overall security capabilities.

In at least one embodiment, to detect human presence effectively within a catalytic converter theft prevention system, several hardware options can be employed. Motion sensors are adept at detecting movement by sensing changes in infrared radiation or using microwave Doppler radar, making them suitable for alerting to human motion. Ultrasonic sensors emit high-frequency sound waves and detect their reflections off nearby objects, effectively identifying the presence of humans within their range. Infrared sensors detect infrared radiation emitted by objects, including humans, with passive infrared (PIR) sensors being particularly useful for detecting changes in heat signatures indicative of human presence. Combining these sensor types can enhance accuracy and reduce false alarms by cross-verifying detected signals. Additionally, technologies akin to those found in trail cameras may be integrated, featuring motion detection via PIR sensors and visual imaging capabilities to capture evidence of detected activity. The selection of these hardware components depends on factors such as detection range, environmental conditions, power efficiency, and integration feasibility within the theft prevention system. By leveraging these technologies, the system can effectively monitor and respond to unauthorized human activities, bolstering security measures for vehicle owners against catalytic converter theft.

In implementations, one or more notification alerts may facilitate a vehicle owner is promptly informed and able to respond swiftly to potential threats. These alerts encompass various communication methods designed to provide immediate notifications. Text messages are sent directly to the owner's cellphone, offering real-time updates on detected suspicious activity. This enables owners to take immediate action, whether contacting authorities or remotely assessing the situation. Alternatively, email notifications serve as detailed alerts, offering comprehensive information or system status updates. Integration with mobile applications allows for personalized alerts delivered directly to the owner's smartphone or tablet, accompanied by event logs and live video feeds where applicable. Audible alarms within the vehicle emit loud sounds to alert nearby individuals, deterring theft attempts and prompting swift intervention from authorities or bystanders. Visual alerts, such as flashing lights or indicators on the app interface, provide instant visual confirmation of system status or detected events. Some systems may also link with third-party monitoring services for continuous surveillance and professional response to triggered alerts, ensuring comprehensive security monitoring around the clock. These notification methods collectively enhance the effectiveness of the theft prevention system, empowering owners to mitigate risks and protect their vehicles proactively.

Integrating video storage into a catalytic converter theft prevention system involves several steps to ensure efficient capture, storage, and management of videos. First, a high-resolution camera with night vision capabilities is installed at an optimal location on the vehicle to monitor the catalytic converter. This camera is connected to a microcontroller, which processes video feeds and manages recording based on inputs from motion sensors or limit switches. The system's power is supplied by the vehicle's battery, supplemented with an internal battery for continuous operation. Initially, captured videos are stored on an SD card or internal memory within the system. To optimize storage efficiency, a video compression algorithm is implemented in the microcontroller firmware, reducing file size before transmission. Data transmission is facilitated by Wi-Fi, Bluetooth, or cellular modules, ensuring secure transfer of compressed video files to a remote database. The remote server, equipped with a robust database management system (DBMS), stores and manages the uploaded videos. A mobile app or web interface allows the vehicle owner to access live feeds, view recorded videos, and manage system settings. Real-time notifications are sent to the owner's mobile device whenever a video is captured, with links to the stored videos in the database. This integration ensures that all captured videos are securely stored and easily accessible, providing a comprehensive security solution for protecting the catalytic converter.

Integrating a limit switch into the power source of a catalytic converter theft prevention system requires careful attention to prevent overcharging of the vehicle's battery. The limit switch is mounted in a critical location, such as near the catalytic converter, to detect tampering. It is connected to the input pins of a microcontroller, which monitors the switch's state and triggers the system's response when the switch is activated. The system's primary power source is the vehicle's battery, supplemented by an internal backup battery. The connection to the vehicle's battery is managed through a voltage regulator, ensuring that the system components receive a stable voltage. A charging circuit allows the internal battery to charge from the vehicle's battery when the vehicle is running, and a diode is placed between the vehicle's battery and the charging circuit to prevent backflow of current, protecting the vehicle's battery from being drained.

A power management circuit continuously monitors the voltage levels of both the vehicle's battery and the internal battery. This circuit ensures that the internal battery charges only when its voltage drops below a certain threshold and stops charging once the internal battery is full or if the vehicle's battery voltage drops below a safe level. The microcontroller is programmed to oversee this process, ensuring that the internal battery does not overcharge and that the vehicle's battery is not excessively drained. This setup ensures that the limit switch and power management system work together to provide reliable operation of the theft prevention system without compromising the health of the vehicle.

With respect to the above description, it is to be realized that the optimum dimensional relationship for the various components of the invention described above and in the illustrations include variations in size, materials, shape, form, function, and manner of operation, assembly and use, are deemed readily apparent and obvious to one skilled in the art, and all equivalent relationships to those illustrates in the drawings and described in the specification are intended to be encompassed by the invention.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A theft deterrent device for a catalytic converter for a vehicle, comprising:
a housing, comprising:
a power source;
a control logic circuitry electrically connected to the power source;
one or more sensors electrically connected to the power source and to the control logic circuitry;
one or more alarms electrically connected to the power source and to the control logic circuitry;
a communication processor electrically connected to the control logic circuitry; and
the control logic circuitry configured to:
in response to detecting motion from a first sensor of the one or more sensors, activate the one or more alarms.

2. The theft deterrent device for a catalytic converter for a vehicle of claim 1, wherein the one or more sensors is located within a proximity to the catalytic converter of the vehicle.

3. The theft deterrent device for a catalytic converter for a vehicle of claim 1, wherein the communication processor is a transceiver.

4. The theft deterrent device for a catalytic converter for a vehicle of claim 1, wherein the one or more alarms is a light emitting diode.

5. The theft deterrent device for a catalytic converter for a vehicle of claim 4, wherein the light emitting diode is electrically connected to a strobe controller.

6. The theft deterrent device for a catalytic converter for a vehicle of claim 4, wherein the one or more alarms is a speaker electrically connected to a driver circuit to emit an audio signal.

7. The theft deterrent device for a catalytic converter for a vehicle of claim 1, wherein the power source is a rechargeable battery to be energized by a power source of the vehicle.

8. The theft deterrent device for a catalytic converter for a vehicle of claim 7, further comprising:
a limit switch electrically connected to the power source and to a voltage regulator, the voltage regulator in communication with the power source of the vehicle.

9. The theft deterrent device for a catalytic converter for a vehicle of claim 1, further comprising a second sensor of the one or more sensors being a camera.

10. The theft deterrent device for a catalytic converter for a vehicle of claim 9, wherein the control logic circuitry is further to:
analyze data collected from the first sensor of the one or more sensors; and
activate the camera when a presence of motion is detected by the first sensor.

11. The theft deterrent device for a catalytic converter for a vehicle of claim 10, further comprising:
a remote database;
the control logic circuitry is further to:
transmit one or more videos captured by the camera to the remote database.

12. A method for detecting movement at a catalytic converter of a vehicle, comprising:
disposing a theft deterrent device at the catalytic converter of the vehicle;
implementing the theft deterrent device, comprising:
a housing, comprising:
a power source;
one or more sensors electrically connected to the power source;
one or more alarms electrically connected to the power source;
a communication processor;
a memory circuit storing computer executable instructions; and
a processing device, wherein execution of the computer executable instructions by the processing device, causes the processing device to:
in response to detecting motion from a first sensor of the one or more sensors, initiate a system setup;
establishing a network connection using a startup subroutine; and
transmitting startup data to a startup routine;
determining a presence of detected motion at the catalytic converter;
evaluating if the detected motion exceeds a predefined threshold; and
activating an alert subroutine when the detected motion exceeds the predefined threshold.

13. The method of claim 12, wherein the alert subroutine activates the one or more alarms to illuminate one or more light emitting diodes.

14. The method of claim 12, wherein the alert subroutine activates the one or more alarms is to emit an audio signal from a speaker electrically connected to a driver circuit.

15. A device, comprising:
a housing, comprising:
a power source;
a control logic circuitry electrically connected to the power source;
one or more sensors electrically connected to the power source and to the control logic circuitry;
one or more alarms electrically connected to the power source and to the control logic circuitry;
a communication processor electrically connected to the control logic circuitry; and
the control logic circuitry configured to:
in response to detecting motion at a catalytic converter of a vehicle from a first sensor of the one or more sensors, activate the one or more alarms.

16. The device of claim 15, wherein the one or more sensors is located within a proximity to the catalytic converter of the vehicle.

17. The device of claim 15, wherein the communication processor is a transceiver.

18. The device of claim 15, wherein the one or more alarms is a light emitting diode.

19. The device of claim 18, wherein the light emitting diode is electrically connected to a strobe controller.

20. The device of claim 15, wherein the one or more alarms is a speaker electrically connected to a driver circuit to emit an audio signal.
